(19) United States
(12) Patent Application Publication
(10) Pub. No.: US 2023/0098578 A1
(43) Pub. Date: Mar. 30, 2023

(54) VEHICLE CONTROL DEVICE

(71) Applicant: Mazda Motor Corporation, Aki-gun (JP)

(72) Inventors: Shinya Morishita, Aki-gun (JP); Daichi Osumi, Aki-gun (JP)

(21) Appl. No.: 17/900,732

(22) Filed: Aug. 31, 2022

(30) Foreign Application Priority Data
Sep. 27, 2021 (JP) 2021-156609

(51) Int. Cl. B60L 15/20; B60L 7/10

(52) U.S. Cl. CPC B60L 15/2009; B60L 7/10; B60L 2250/28; B60L 2240/423; B60L 2240/14

(57) ABSTRACT

A control device for a vehicle is provided, which includes a power source that generates torque for driving or braking the vehicle, an accelerator pedal sensor that detects an operating amount of an accelerator pedal, and a control unit that controls the power source. The control unit sets a target acceleration based on the accelerator pedal operating amount detected by the accelerator pedal sensor. The control unit sets a target jerk based on the target acceleration, and when the target acceleration decreases toward 0 from a value above 0, sets the target jerk so that an absolute value of the target jerk becomes smaller as the target acceleration approaches 0. The control unit sets torque to be outputted or regenerated by the power source, based on the target acceleration and the target jerk.

### TECHNICAL FIELD

The present disclosure relates to a control device for a vehicle.

### BACKGROUND OF THE DISCLOSURE

Conventionally, it is known that control devices for vehicles control an output torque of a power source according to driver's operation of an accelerator pedal. For example, JP2016-217294A discloses a control device for an engine, which sets a target acceleration of a vehicle based on an accelerator opening, and controls engine torque so that the target acceleration is realized. Thus, the control device sets an acceleration characteristic in which a relationship between the accelerator opening and the target acceleration is defined so that a desired jerk is produced on the vehicle when the driver steps on the accelerator pedal. Further, the control device imposes a restriction to a change in the target torque according to the target acceleration so that the jerk produced on the vehicle does not exceed a given value when the accelerator opening is decreased.

Meanwhile, some vehicles provided with an electric motor as the power source, such as electric vehicles and hybrid vehicles can control not only the acceleration of the vehicle but also deceleration of the vehicle according to operation of an accelerator pedal. In such vehicles, when the accelerator pedal is rapidly operated while the acceleration is changing from acceleration to deceleration passing through 0, the attitude of the vehicle in the pitch direction changes greatly via the horizontal posture. As a result, a force applied to the driver's neck changes greatly forward and backward, thereby ruining the driver's comfort.

### SUMMARY OF THE DISCLOSURE

The present disclosure is made in order to solve the above problem of the conventional technology, and one purpose thereof is to provide a control device for a vehicle, capable of making an attitude change of the vehicle mild, when acceleration of the vehicle changes from acceleration to deceleration.

According to one aspect of the present disclosure, a control device for a vehicle is provided, which includes a power source that generates torque for driving or braking the vehicle, an accelerator pedal sensor that detects an operating amount of an accelerator pedal, and a control unit that controls the power source. The control unit sets a target acceleration based on the accelerator pedal operating amount detected by the accelerator pedal sensor. The control unit sets a target jerk based on the target acceleration, and when the target acceleration decreases toward 0 from a value above 0, sets the target jerk so that an absolute value of the target jerk becomes smaller as the target acceleration approaches 0. The control unit sets torque to be outputted or regenerated by the power source, based on the target acceleration and the target jerk. According to this configuration, since a rate of change in the acceleration of the vehicle becomes smaller as the target acceleration of the vehicle approaches 0 from a positive value, an attitude change can be milder as the attitude of the vehicle in the pitch direction approaches a horizontal posture from a rearward inclining posture, even when the accelerator pedal is returned by a driver rapidly during acceleration. Therefore, it can suppress a rapid change in a force applied to the driver's neck when the attitude of the vehicle in the pitch direction changes across the horizontal posture, thereby maintaining the driver's comfort.

The control unit may set the target jerk so that a rate of change in the target jerk according to the change in the target acceleration when the target acceleration decreases from a value below 0 becomes smaller than the rate of the change in the target jerk according to the change in the target acceleration when the target acceleration decreases toward 0 from a value above 0. According to this configuration, since the rate of change in the acceleration of the vehicle after the target acceleration of the vehicle decreased from the positive value and passed through 0 becomes small, the attitude change after the attitude of the vehicle in the pitch direction changed from the rearward inclining posture to a forward inclining posture via the horizontal posture can be milder, even when the accelerator pedal is returned rapidly during the acceleration.

The control unit may acquire an operating speed of the accelerator pedal based on the accelerator pedal operating amount, and when the accelerator pedal operating amount decreases, the control unit may set the target jerk so that the absolute value of the target jerk becomes larger as an absolute value of the accelerator pedal operating speed becomes larger. According to this configuration, the rate of change in the acceleration can be increased as the driver returns the accelerator pedal more rapidly, thereby reflecting the intention of the driver who operates the accelerator pedal.

When the target acceleration decreases from a value below 0, the control unit may set the target jerk so that the absolute value of the target jerk becomes smaller as an absolute value of the target acceleration becomes larger. According to this configuration, the rate of increase in the absolute value of the acceleration (i.e., a rate of increase in deceleration) of the vehicle becomes smaller as the absolute value of the target acceleration (i.e., a target deceleration) of the vehicle becomes larger in response to the return of the accelerator pedal, and thus, a heavy braking feel can be eased.

The power source may be an electric motor. According to this configuration, since the power source is the electric motor, the torque for driving or braking the vehicle according to the target acceleration setting and the target jerk setting can be controlled with sufficient accuracy.

### BRIEF DESCRIPTION OF DRAWINGS

FIG. 1 is a plan view illustrating an outline configuration of a vehicle to which a control device for a vehicle according to one embodiment of the present disclosure is applied.

FIG. 2 is a block diagram illustrating a functional configuration of the control device for the vehicle according to this embodiment of the present disclosure.

FIG. 3 is a control block diagram of the control device for the vehicle according to this embodiment of the present disclosure.

FIG. 4 is a view illustrating one example of a target jerk map when an accelerator pedal is depressed according to this embodiment of the present disclosure.

FIG. 5 is a view illustrating one example of a target jerk map when the accelerator pedal is released according to this embodiment of the present disclosure.

FIG. 6 is a flowchart illustrating a torque control processing according to this embodiment of the present disclosure.

### DETAILED DESCRIPTION OF THE DISCLOSURE

Hereinafter, a control device for a vehicle according to one embodiment of the present disclosure is described with reference to the accompanying drawings.

### <System Configuration>

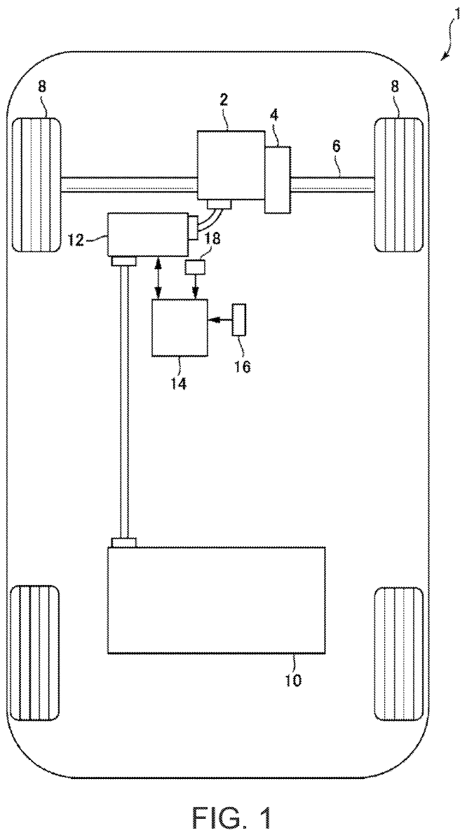

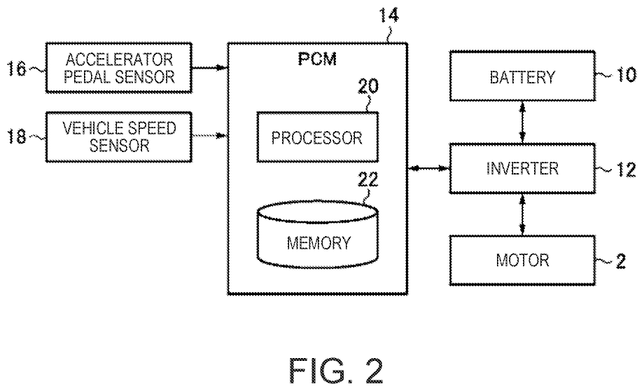

First, referring to FIGS. 1 and 2, a configuration of the control device for the vehicle according to this embodiment is described. FIG. 1 is a plan view illustrating an outline configuration of the vehicle to which the control device for the vehicle according to this embodiment is applied, and FIG. 2 is a block diagram illustrating a functional configuration of the control device for the vehicle according to this embodiment.

As illustrated in FIG. 1, a vehicle 1 of this embodiment is an electric vehicle which carries a motor 2 as a power source which generates torque for driving or braking the vehicle 1. The motor 2 is mounted, for example, on a front part of the vehicle 1. The torque outputted from the motor 2 is transmitted to a transmission 4. The transmission 4 outputs the output torque of the motor 2 to a pair of drive shafts 6 at a given gear ratio. Therefore, a pair of driving wheels 8 (in the example of FIG. 1, left and right front wheels) attached to outer end parts of the respective drive shafts 6 in the vehicle width direction are driven.

A battery 10 which supplies electric power to the motor 2 is mounted, for example, on a rear part of the vehicle 1. Further, an inverter 12 is disposed near the motor 2. The inverter 12 charges the battery 10, by converting DC power supplied from the battery 10 into AC power and supplying it to the motor 2, and by converting power regenerated by the motor 2 into DC power and supplying it to the battery 10. Further, the inverter 12 is electrically connected to a PCM (Powertrain Control Module) 14, and can input and output a control signal with the PCM 14.

Further, the vehicle 1 has an accelerator pedal sensor 16 which detects an opening of an accelerator pedal (corresponding to a stepped-on amount of the accelerator pedal by a driver), and a vehicle speed sensor 18 which detects a vehicle speed. Each of the sensors is electrically connected to the PCM 14 directly or indirectly, and outputs a detection signal corresponding to its detection value to the PCM 14.

In the vehicle 1, the PCM 14 performs various kinds of controls. In this embodiment, the PCM 14 functions as a controller (control unit) of the powertrain system of the vehicle 1. That is, the PCM 14 controls the inverter 12 according to the driver's operation of the accelerator pedal to supply the power from the battery 10 to the motor 2 via the inverter 12, or to supply the regenerated power from the motor 2 to the battery 10, thereby realizing a desired output torque or regeneration torque according to the accelerator operation.

As illustrated in FIG. 2, the PCM 14 has a processor 20, and memory 22 (ROM, RAM, etc.) which stores various kinds of programs which are interpreted and executed by the processor 20 (including a primary control program such as an operating system (OS), and an application program which runs on the OS and realizes a specific function), and various kinds of data.

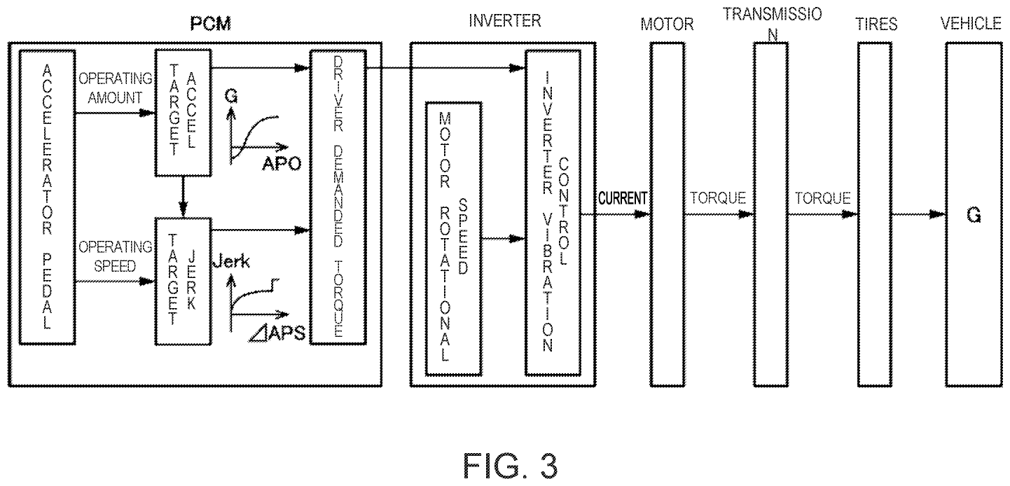

Next, referring to FIG. 3, an outline of the control by the control device for the vehicle of this embodiment is described. FIG. 3 is a control block diagram of the control device for the vehicle according to this embodiment of the present disclosure.

As illustrated in FIG. 3, the PCM 14 sets a target acceleration based on the operating amount of the accelerator pedal (target acceleration setting). For example, the target acceleration is set so that it becomes a negative value when the operating amount of the accelerator pedal is less than a given value (for example, 20%), it becomes 0 [m/s²] when the operating amount of the accelerator pedal is at the given value, and it becomes a positive value when the operating amount of the accelerator pedal is more than the given value. That is, the target acceleration increases as the operating amount of the accelerator pedal increases (i.e., as stepping on the accelerator pedal more). Further, the PCM 14 may set the target acceleration so that the target acceleration becomes larger when the vehicle speed is low than when the vehicle speed is high.

Moreover, the PCM 14 sets a target jerk based on the target acceleration setting and an operating speed of the accelerator pedal (target jerk setting). Then, based on the target acceleration and the target jerk which are set, the PCM 14 calculates a driver demanded torque. For example, the PCM 14 calculates a torque to be generated by the motor 2 in order to accelerate or decelerate the vehicle 1 at the target acceleration. Then, when changing the driver demanded torque to the calculated torque, the PCM 14 determines a rate of change in the driver demanded torque so that the rate of change in the acceleration of the vehicle 1 becomes the target jerk. Based on this rate of change and the driver demanded torque in the last instruction executing cycle, the PCM 14 calculates a driver demanded torque in the current instruction executing cycle and outputs it to the inverter 12.

The inverter 12 performs a vibration control based on the driver demanded torque inputted from the PCM 14, and a rotational speed of the motor 2. For example, the inverter 12 suppresses the natural vibration frequency component of the power transmission system of the vehicle 1 at the driver demanded torque, and calculates a command value of the driving torque or the regeneration torque of the motor 2 so that the rotational speed vibration of the motor 2 is suppressed. Then, based on the calculated command value, the PCM 14 controls current which flows into the motor 2.

When the motor 2 generates the torque according to the current control of the inverter 12, this torque is then transmitted to the transmission 4. The transmission 4 outputs the torque of the motor 2 to the drive shafts 6 at a given gear ratio. Therefore, the driving torque or the braking torque is transmitted to the ground via tires of the pair of driving wheels 8 attached to the drive shafts 6 to accelerate or decelerate the vehicle 1.

### <Relationship Between Target Acceleration and Target Jerk>

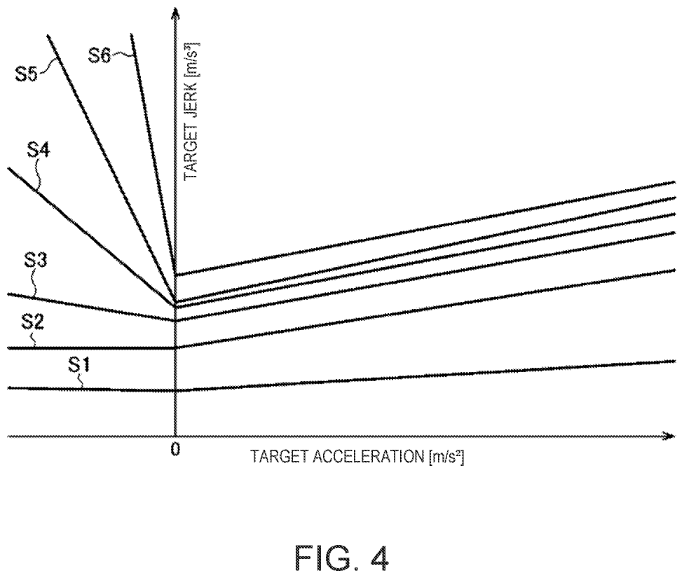

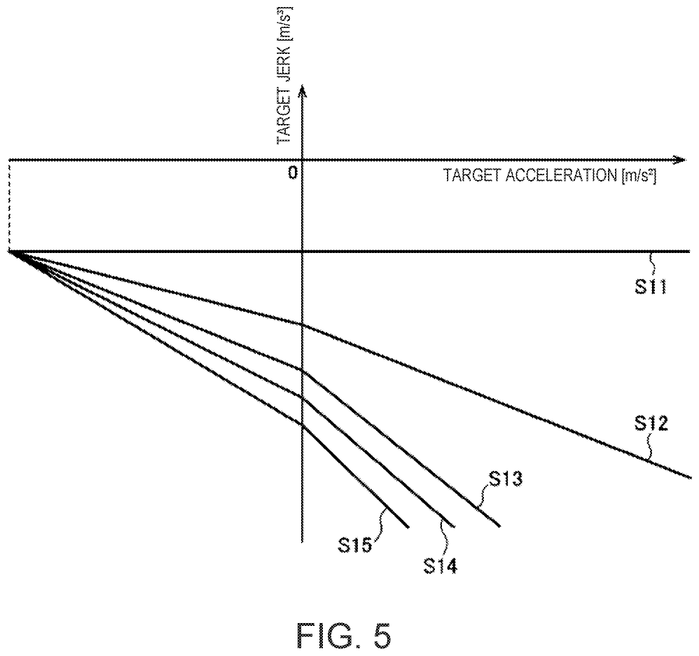

Next, referring to FIGS. 4 and 5, a relationship between the target acceleration and the target jerk is described. FIG. 4 is a view illustrating one example of a target jerk map indicative of the relationship between the target acceleration and the target jerk, when the accelerator pedal is depressed according to this embodiment of the present disclosure, and FIG. 5 is a view illustrating one example of a target jerk map when the accelerator pedal is released according to this embodiment of the present disclosure. In FIGS. 4 and 5, the horizontal axis indicates a target acceleration [m/s²] and the vertical axis indicates a target jerk [m/s³]. The positive target acceleration means that a target acceleration for accelerating the vehicle 1 forward is set, and the negative target acceleration means that a target acceleration for decelerating the vehicle 1 forward is set.

When the target acceleration increases according to the depression of the accelerator pedal, the target jerk is set as illustrated by the map in FIG. 4. S1-S6 in FIG. 4 represent target jerk maps at different accelerator pedal operating speeds S1-S6 [%/s], and a relationship between the accelerator pedal operating speeds is S1<S2<S3<S4<S5<S6. When the accelerator pedal is depressed (i.e., when the operating amount of the accelerator pedal increases), the target jerk becomes larger as the accelerator pedal operating speed increases for the same target acceleration (i.e., as a speed of depressing the accelerator pedal becomes faster), as illustrated in FIG. 4.

As illustrated by S3-S6 in FIG. 4, when the accelerator pedal operating speed is above a given value (a value between S2 and S3 in this embodiment), as the accelerator pedal is depressed more, the target acceleration increases toward 0 (zero) from a value below 0, and as it approaches 0, the target jerk becomes smaller. That is, when the accelerator pedal operating speed is relatively high, since a rate of change in the acceleration of the vehicle 1 becomes smaller as the target acceleration of the vehicle 1 approaches 0 from the negative value, the attitude change can be milder, as the attitude of the vehicle 1 in the pitch direction approaches the horizontal posture from the forward inclining posture, even when the accelerator pedal is operated rapidly.

Further, as illustrated by S1 and S2 in FIG. 4, when the accelerator pedal operating speed is below the given value, the target jerk is constant within a range of the target acceleration below 0. That is, when the accelerator pedal operating speed is relatively low, since the rate of change in the acceleration of the vehicle 1 does not change as the target acceleration of the vehicle 1 approaches 0 from the negative value, the degree of change of the attitude of the vehicle 1 in the pitch direction as approaching the horizontal posture from the forward inclining posture does not change, either.

Further, when the target acceleration increases from a value above 0 according to the depression of the accelerator pedal, the target jerk becomes larger as the target acceleration increases, as illustrated by S1-S6 in FIG. 4. That is, since a rate of increase in the acceleration of the vehicle 1 becomes larger as the target acceleration increases according to the depression of the accelerator pedal, a continuous acceleration feel can be realized.

Here, when the accelerator pedal operating speed is above a given value (a value between S3 and S4 in this embodiment), as illustrated by S4-S6 in FIG. 4, the rate of change in the target jerk (a slope of each line in FIG. 4) according to the change in the target acceleration when the target acceleration increases from a value above 0 is smaller than the rate of change in the target jerk according to the change in the target acceleration when the target acceleration increases toward 0 from a value below 0. That is, when the accelerator pedal operating speed is relatively high, a rate of change in the acceleration of the vehicle 1 after the target acceleration of the vehicle 1 increased from the negative value and exceeded 0 becomes smaller, and thus, the attitude change after the attitude of the vehicle 1 in the pitch direction changed from the forward inclining posture to a rearward inclining posture via the horizontal posture can be milder, even when the accelerator pedal is operated rapidly.

On the other hand, when the target acceleration decreases according to the release of the accelerator pedal, the target jerk is set as illustrated by the map in FIG. 5. S11-S15 in FIG. 5 represent target jerk maps for different accelerator pedal operating speeds S11-S15 [%/s], and a relationship between the absolute values of the accelerator pedal operating speeds is S11<S12<S13<S14<S15. When the accelerator pedal is released (i.e., when the operating amount of the accelerator pedal decreases), the absolute value of the target jerk becomes larger for the same target acceleration as the absolute value of the operating speed of the accelerator pedal is larger (i.e., as a speed of releasing the accelerator pedal becomes faster) as illustrated in FIG. 5.

When the absolute value of the accelerator pedal operating speed is above a given value (a value between S11 and S12 in this embodiment), as illustrated by S12-S15 in FIG. 5, the absolute value of the target jerk becomes smaller as the target acceleration decreases toward 0 from a value above 0, and approaches 0, according to the release of the accelerator pedal. That is, when the absolute value of the accelerator pedal operating speed is relatively high, since a rate of change in the acceleration of the vehicle 1 becomes smaller as the target acceleration of the vehicle 1 approaches 0 from the positive value, the attitude change can be milder as the attitude of the vehicle 1 in the pitch direction approaches the horizontal posture from the rearward inclining posture, even when the accelerator pedal is operated rapidly.

Further, as illustrated by S11 in FIG. 5, when the accelerator pedal operating speed is below the given value, the target jerk is constant regardless of the target acceleration. That is, since the rate of change in the acceleration of the vehicle 1 does not change when the accelerator pedal operating speed is relatively low, the rate of change in the attitude of the vehicle 1 in the pitch direction as approaching the horizontal posture from the rearward inclining posture does not change, either.

Further, when the target acceleration decreases from a value below 0 according to the release of the accelerator pedal, the target jerk becomes smaller as the absolute value of the target acceleration becomes larger, as illustrated by S12-S15 in FIG. 4. That is, since a rate of increase in the absolute value of the acceleration of the vehicle 1 (i.e., a rate of increase in the deceleration) becomes smaller as the absolute value of the target acceleration (i.e., a target deceleration) becomes larger according to the release of the accelerator pedal, a heavy braking feel can be eased.

Here, as illustrated by S12-S15 in FIG. 4, when the absolute value of the accelerator pedal operating speed is above the given value (the value between S11 and S12 in this embodiment), the rate of change in the target jerk (a slope of each line in FIG. 5) according to the change in the target acceleration when the target acceleration decreases from a value below 0 is smaller than the rate of change in the target jerk according to the change in the target acceleration when the target acceleration decreases toward 0 from a value above 0. That is, when the absolute value of the accelerator pedal operating speed is relatively high, the rate of change in the acceleration of the vehicle 1 after the target acceleration of the vehicle 1 decreased from the positive value and passed through 0 becomes smaller, and thus, the attitude change after the attitude of the vehicle 1 in the pitch direction changed from the rearward inclining posture to the forward inclining posture via the horizontal posture can be milder, even when the accelerator pedal is operated rapidly.

### <Control Processing>

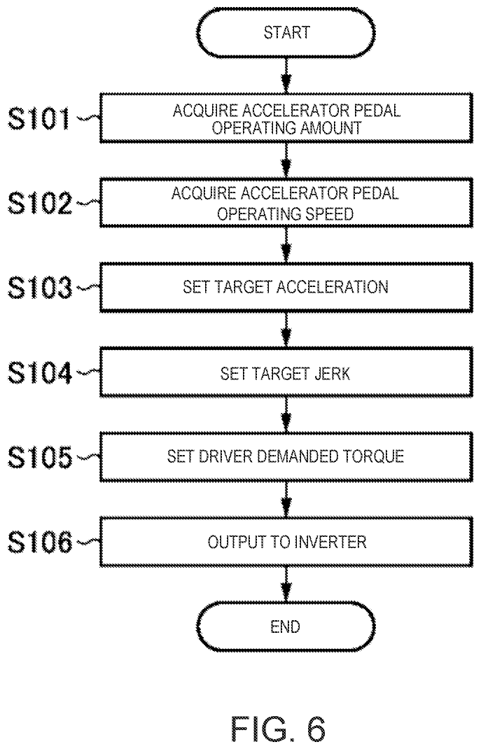

Next, referring to FIG. 6, a torque control processing according to this embodiment is described. FIG. 6 is a flowchart illustrating the torque control processing according to this embodiment. This flow is started by the PCM 14 when the power of the vehicle 1 is turned on, and it is repeated at a given cycle.

First, at Step S101, the PCM 14 acquires an accelerator pedal operating amount detected by the accelerator pedal sensor 16. At this time, the PCM 14 may acquire a vehicle speed detected by the vehicle speed sensor 18.

Next, at Step S102, the PCM 14 acquires an accelerator pedal operating speed by calculating a derivative of the accelerator pedal operating amount acquired at Step S101 with respect to time.

Next, at Step S103, the PCM 14 sets a target acceleration based on the accelerator pedal operating amount acquired at Step S101. For example, the target acceleration becomes a negative value when the operating amount of the accelerator pedal is less than the given value (for example, 20%), and it becomes 0 [m/s²] at the given value, and it becomes a positive value when the operating amount of the accelerator pedal is larger than the given value. The target acceleration is set so that it becomes larger as the operating amount of the accelerator pedal increases (i.e., as stepping on the accelerator pedal more). Further, when the vehicle speed is acquired at Step S101, the PCM 14 may set the target acceleration so that the target acceleration becomes larger when the vehicle speed is low than when the vehicle speed is high.

Next, at Step S104, the PCM 14 sets the target jerk based on the target acceleration set at Step S103 and the accelerator pedal operating speed acquired at Step S102. When the accelerator pedal is depressed, the PCM 14 sets the target jerk according to the target acceleration and the accelerator pedal operating speed based on the map as illustrated in FIG. 4. Further, when the accelerator pedal is being returned, the PCM 14 sets the target jerk according to the target acceleration and the accelerator pedal operating speed based on the map as illustrated in FIG. 5.

Next, at Step S105, the PCM 14 sets a driver demanded torque based on the target acceleration set at Step S103 and the target jerk set at Step S104. For example, the PCM 14 calculates a torque to be generated by the motor 2 in order to accelerate or decelerate the vehicle 1 at the target acceleration. Then, when changing the driver demanded torque to the calculated torque, the PCM 14 determines the rate of change in the driver demanded torque so that the rate of change in the acceleration of the vehicle 1 becomes the target jerk. Based on this rate of change and the driver demanded torque in the last instruction executing cycle, the PCM 14 sets a driver demanded torque in the current instruction executing cycle.

Next, at Step S106, the PCM 14 outputs the driver demanded torque set at Step S105 to the inverter 12. Therefore, the inverter 12 controls the current which flows into the motor 2 based on the driver demanded torque inputted from the PCM 14. After Step S106, the PCM 14 ends the torque control processing in the current instruction executing cycle.

### <Modifications>

Next, modifications of this embodiment of the present disclosure are described. Although in the above embodiment the motor 2 is mounted on the vehicle 1 as the power source which generates the torque for driving or braking the vehicle 1, an internal combustion engine, such as a gasoline engine and a diesel engine, may be mounted as the power source, in addition to or instead of the motor 2. In this case, the PCM 14 controls a throttle valve, a fuel injection valve, a variable valve operating mechanism, etc. of the internal combustion engine at Step S106 of FIG. 6 based on the driver demanded torque set at Step S105.

### <Operation and Effects>

Next, operation and effects of the control device for the vehicle according to the above embodiment and the modification are described.

First, when the target acceleration increases toward 0 from a value below 0, the PCM 14 sets the target jerk so that the target jerk becomes smaller as the target acceleration approaches 0, and sets the torque which the power source outputs or regenerates based on the target acceleration and the target jerk. Therefore, since the rate of change in the acceleration of the vehicle 1 becomes smaller as the target acceleration of the vehicle 1 approaches 0 from the negative value, the attitude change can be milder as the attitude of the vehicle 1 in the pitch direction approaches the horizontal posture from the forward inclining posture, even when the driver steps on the accelerator pedal rapidly during the deceleration. Thus, it can suppress a rapid change in the force applied to the driver's neck when the attitude of the vehicle 1 in the pitch direction changes across the horizontal posture, thereby maintaining the driver's comfort.

Further, the PCM 14 sets the target jerk so that the rate of change in the target jerk according to the change in the target acceleration when the target acceleration increases from a value above 0 become smaller than the rate of change in the target jerk according to the change in the target acceleration when the target acceleration increases toward 0 from a value below 0. Therefore, since the rate of change in the acceleration of the vehicle 1 after the target acceleration of the vehicle 1 increased from the negative value and passed through 0 becomes smaller, the attitude change after the attitude of the vehicle 1 in the pitch direction changed from the forward inclining posture to the rearward inclining posture via the horizontal posture can be milder, even when the driver steps on the accelerator pedal rapidly during the deceleration.

Further, when the accelerator pedal operating amount increases, the PCM 14 sets the target jerk so that the target jerk becomes larger as the accelerator pedal operating speed increases. Therefore, the rate of change in the acceleration can be increased as the driver steps on the accelerator pedal more rapidly, thereby reflecting the intention of the driver who operates the accelerator pedal.

Further, when the target acceleration increases toward 0 from a value below 0 and the accelerator pedal operating speed is above the given value, the PCM 14 sets the target jerk so that the target jerk becomes smaller as the target acceleration approaches 0. Therefore, when the driver steps on the accelerator pedal during the deceleration rapidly beyond the given value, the rate of change in the acceleration of the vehicle 1 becomes smaller as the target acceleration of the vehicle 1 approaches 0 from the negative value, and thus, the attitude change can be milder as the attitude of the vehicle 1 in the pitch direction approaches the horizontal posture from the forward inclining posture. Thus, when the attitude of the vehicle 1 in the pitch direction changes across the horizontal posture according to the rapid operation of the accelerator pedal, the rapid change in the force being applied to the driver's neck can be suppressed certainly.

Further, when the target acceleration decreases toward 0 from a value above 0, the PCM 14 sets the target jerk so that the absolute value of the target jerk becomes smaller as the target acceleration approaches 0. Therefore, since the rate of change in the acceleration of the vehicle 1 becomes smaller as the target acceleration of the vehicle 1 approaches 0 from the positive value, the attitude change can be milder as the attitude of the vehicle 1 in the pitch direction approaches the horizontal posture from the rearward inclining posture, even when the driver returns the accelerator pedal rapidly during the acceleration. Thus, it can suppress the rapid change in the force being applied to the driver's neck when the attitude of the vehicle 1 in the pitch direction changes across the horizontal posture, thereby maintaining the driver's comfort.

Further, when the target acceleration increases from a value above 0, the PCM 14 sets the target jerk so that the target jerk becomes larger as the target acceleration increases. Therefore, since the rate of increase in the acceleration of the vehicle 1 becomes larger as the target acceleration increases according to the depression of the accelerator pedal, the continuous acceleration feel can be realized.

Further, the PCM 14 sets the target jerk so that the rate of change in the target jerk according to the change in the target acceleration when the target acceleration decreases from a value below 0 becomes smaller than the rate of the change in the target jerk according to the change in the target acceleration when the target acceleration decreases toward 0 from a value above 0. Therefore, since the rate of change in the acceleration of the vehicle 1 after the target acceleration of the vehicle 1 decreased from the positive value and passed through 0 becomes smaller, the attitude change after the attitude of the vehicle 1 in the pitch direction changed from the rearward inclining posture to the forward inclining posture via the horizontal posture can be milder, even when the accelerator pedal is rapidly returned during the acceleration.

Further, when the accelerator pedal operating amount decreases, the PCM 14 sets the target jerk so that the absolute value of the target jerk becomes larger as the absolute value of the accelerator pedal operating speed becomes larger. Therefore, the rate of change in the acceleration can be increased as the driver releases the accelerator pedal more rapidly, thereby reflecting the intention of the driver who operates the accelerator pedal.

Further, when the target acceleration decreases from a value below 0, the PCM 14 sets the target jerk so that the absolute value of the target jerk becomes smaller as the absolute value of the target acceleration becomes larger. Therefore, since the rate of increase in the absolute value of the acceleration of the vehicle 1 (i.e., the rate of increase in the deceleration) becomes smaller as the absolute value of the target acceleration (i.e., the target deceleration) becomes larger according to the release of the accelerator pedal, the heavy braking feel can be eased.

Moreover, since the power source is the electric motor, the torque for driving or braking the vehicle 1 according to the target acceleration setting and the target jerk setting can be controlled with sufficient accuracy.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Vehicle
2 Motor
4 Transmission
6 Drive Shaft
8 Driving Wheel
10 Battery
12 Inverter
14 PCM
16 Accelerator Pedal Sensor
18 Vehicle Speed Sensor
20 Processor
22 Memory

What is claimed is:

1. A control device for a vehicle, comprising:
a power source that generates torque for driving or braking the vehicle;
an accelerator pedal sensor that detects an operating amount of an accelerator pedal; and
a control unit that controls the power source, the control unit being configured to:
set a target acceleration based on the accelerator pedal operating amount detected by the accelerator pedal sensor;
set a target jerk based on the target acceleration;
when the target acceleration decreases toward 0 from a value above 0, set the target jerk so that an absolute value of the target jerk becomes smaller as the target acceleration approaches 0; and
set torque to be outputted or regenerated by the power source, based on the target acceleration and the target jerk.

2. The control device of claim 1, wherein the control unit sets the target jerk so that a rate of change in the target jerk according to the change in the target acceleration when the target acceleration decreases from a value below 0 becomes smaller than the rate of the change in the target jerk according to the change in the target acceleration when the target acceleration decreases toward 0 from a value above 0.

3. The control device of claim 2,
wherein the control unit acquires an operating speed of the accelerator pedal based on the accelerator pedal operating amount, and
wherein when the accelerator pedal operating amount decreases, the control unit sets the target jerk so that the absolute value of the target jerk becomes larger as an absolute value of the accelerator pedal operating speed becomes larger.

4. The control device of claim 3, wherein when the target acceleration decreases from a value below 0, the control unit sets the target jerk so that the absolute value of the target jerk becomes smaller as an absolute value of the target acceleration becomes larger.

5. The control device of claim 4, wherein the power source is an electric motor.

6. The control device of claim 1,
wherein the control unit acquires an operating speed of the accelerator pedal based on the accelerator pedal operating amount, and
wherein when the accelerator pedal operating amount decreases, the control unit sets the target jerk so that the absolute value of the target jerk becomes larger as an absolute value of the accelerator pedal operating speed becomes larger.

7. The control device of claim 1, wherein when the target acceleration decreases from a value below 0, the control unit sets the target jerk so that the absolute value of the target jerk becomes smaller as an absolute value of the target acceleration becomes larger.

8. The control device of claim 1, wherein the power source is an electric motor.

9. The control device of claim 2, wherein when the target acceleration decreases from a value below 0, the control unit sets the target jerk so that the absolute value of the target jerk becomes smaller as an absolute value of the target acceleration becomes larger.

10. The control device of claim 2, wherein the power source is an electric motor.

11. The control device of claim 3, wherein the power source is an electric motor.

12. The control device of claim 6, wherein when the target acceleration decreases from a value below 0, the control unit sets the target jerk so that the absolute value of the target jerk becomes smaller as an absolute value of the target acceleration becomes larger.

13. The control device of claim 6, wherein the power source is an electric motor.

14. The control device of claim 7, wherein the power source is an electric motor.

15. The control device of claim 9, wherein the power source is an electric motor.

16. The control device of claim 12, wherein the power source is an electric motor.

17. The control device of claim 1,
wherein the control unit is further configured to:
store a target jerk map indicative of a relationship between the target acceleration and the target jerk when the accelerator pedal is depressed; and
set the target jerk by comparing the accelerator pedal operating speed and the target acceleration set based on the accelerator pedal operating amount with the jerk map, and
wherein the jerk map is configured so that the absolute value of the target jerk becomes smaller as the target acceleration decreases toward 0 from a value above 0.
